(19) United States
(12) Patent Application Publication
(10) Pub. No.: US 2017/0192643 A1
(43) Pub. Date: Jul. 6, 2017

(54) ELECTRONIC DEVICE AND METHOD FOR CREATING THREE-DIMENSIONAL IMAGE

(71) Applicants: NANNING FUGUI PRECISION INDUSTRIAL CO., LTD., Nanning (CN); HON HAI PRECISION INDUSTRY CO., LTD., New Taipei (TW)

(72) Inventor: WEN-HSIN CHANG, New Taipei (TW)

(21) Appl. No.: 15/054,953

(22) Filed: Feb. 26, 2016

(30) Foreign Application Priority Data
Dec. 31, 2015 (TW) 104144814

(51) Int. Cl. G06F 3/0488; G06T 11/20; G06F 3/0484; G06F 3/041

(52) U.S. Cl. CPC G06F 3/0488; G06F 3/0416; G06T 11/203; G06F 3/04845; G06F 2203/04104

(57) ABSTRACT

An electronic device for creating a three-dimensional image includes a display unit and a processing unit. The display unit includes a display screen and a touch sensor electrically coupled to the display screen. The touch sensor generates a touch signal in response to touch input applied on the display screen. The processing unit receives the touch signal and determines a position of the touch input applied on the display screen, determines a length of time of the touch input applied continuously on the display screen, and creates an image on the display screen according to the position and length of time of the touch input applied on the display screen.

### CROSS-REFERENCE TO RELATED APPLICATIONS

This application claims priority to Taiwanese Patent Application No. 104144814 filed on Dec. 31, 2015, the contents of which are incorporated by reference herein.

### FIELD

The subject matter herein generally relates to an electronic device and a method for creating a three-dimensional image on a display screen of the electronic device.

### BACKGROUND

To create a three-dimensional image on a display screen of an electronic device, the electronic device may employ a motion sensor to capture hand gestures of a user. When a distance between the motion sensor and the user increases, an accuracy of capturing the hand gestures decreases.

### BRIEF DESCRIPTION OF THE DRAWINGS

Implementations of the present technology will now be described, by way of example only, with reference to the attached figures.

FIG. 1 is a block diagram of an embodiment of an electronic device for creating a three-dimensional image.

FIG. 2 is a block diagram of a display unit of FIG. 1.

FIG. 3 is a block diagram of a processing unit of FIG. 1.

FIG. 4 is a diagrammatic view of an embodiment of a method for creating an image of a line.

FIG. 5 is a diagrammatic view of an embodiment of a method for creating an image of a quadrilateral.

FIG. 6 is a diagrammatic view of an embodiment of a method for creating an image of a regular triangular prism.

FIG. 7 is a diagrammatic view of an embodiment of a method for creating an image of an irregular triangular prism.

FIG. 8 is a diagrammatic view of an embodiment of a method for creating an image of a pyramid.

FIG. 9 is a diagrammatic view of an embodiment of a method for creating an image of a sphere and a round-ended column.

FIG. 10 is a diagrammatic view of an embodiment of a method for creating an image of a cylinder.

FIG. 11 is a diagrammatic view showing a relationship between a length of an image and pressure and length of time of touch input applied on a display screen.

FIG. 12 is a diagrammatic view showing a relationship between a length of an image and length of time of touch input applied on a display screen and a relationship between a line thickness of the image and pressure of the touch input.

FIG. 13 is a diagrammatic view of an embodiment of a method for rotating an image.

FIG. 14 is a diagrammatic view of an embodiment of a method for scaling down a size of an image.

FIG. 15 is a diagrammatic view of an embodiment of a method for scaling up a size of an image.

FIG. 16 is a flowchart of an embodiment of a method for creating a three-dimensional image on an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

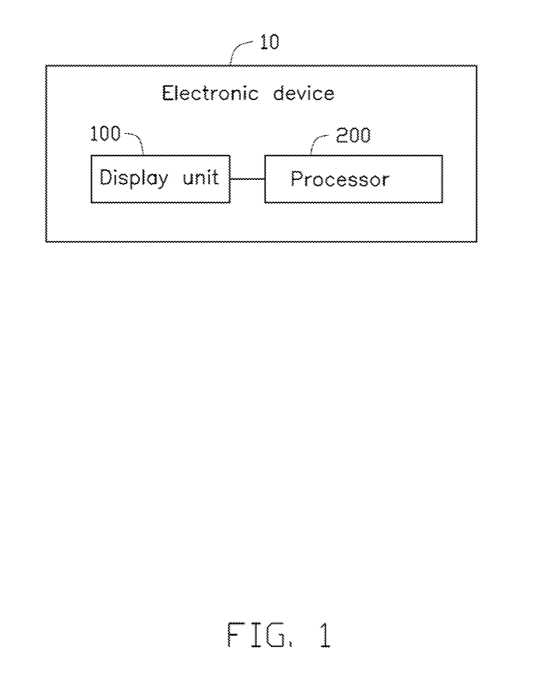

FIG. 1 illustrates an embodiment of an electronic device 10 for creating a three-dimensional image. The electronic device 10 can be a mobile phone, a tablet computer, or the like. The electronic device 10 can include a display unit 100 and a processing unit 200.

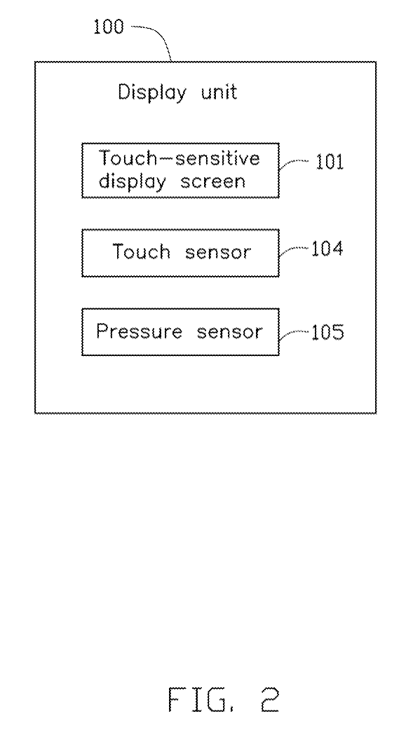

As illustrated in FIG. 2, the display unit 100 can include a display screen 101, a touch sensor 104, and a pressure sensor 105. The touch sensor 104 and the pressure sensor 105 can be electrically coupled to the display screen 101. The touch sensor 104 can detect a touch input on the display screen 101. The pressure sensor 105 can detect a pressure of the touch input on the display screen 101. When the touch sensor 104 detects a touch input on the display screen 101, the touch sensor 104 can generate a touch signal and transmit the touch signal to the processing unit 200. When the pressure sensor 105 detects a pressure on the display screen 101, the pressure sensor 105 can generate a pressure signal and transmit the pressure signal to the display screen 101.

The processing unit 200 can determine, according to the touch signal, a position of touch input applied on the display screen 101. The processing unit 200 can determine a length of time of the touch input being applied continuously on the display screen 101. The processing unit 200 can create an image on the display screen 101 according to the position and the length of time of the touch input. The processing unit 200 can determine a moving direction and a moving distance of the touch input along the display screen 101 and adjust the image according to the moving direction and the moving distance.

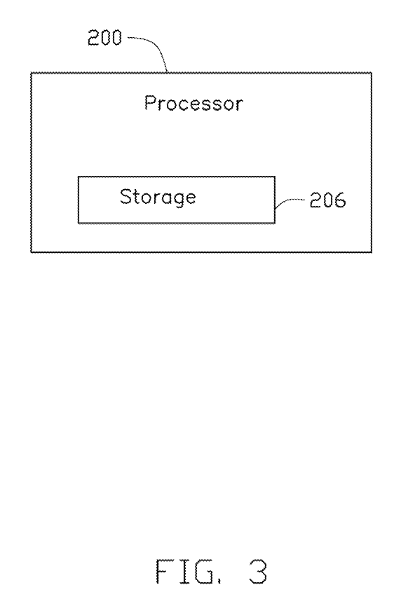

As illustrated in FIG. 3, the processing unit 200 can include a storage unit 206. The storage unit 206 can store a table of a plurality of colors. The table can include a corresponding plurality of pressure values or time durations. In at least one embodiment, the processing unit 200 can adjust a color of the image according to the pressure of the touch input. In another embodiment, the color can be adjusted according to a length of time of the touch input applied continuously on the display screen 101. In another embodiment, the length of the image can be adjusted according to the length of time of the touch input applied continuously on the display screen 101.

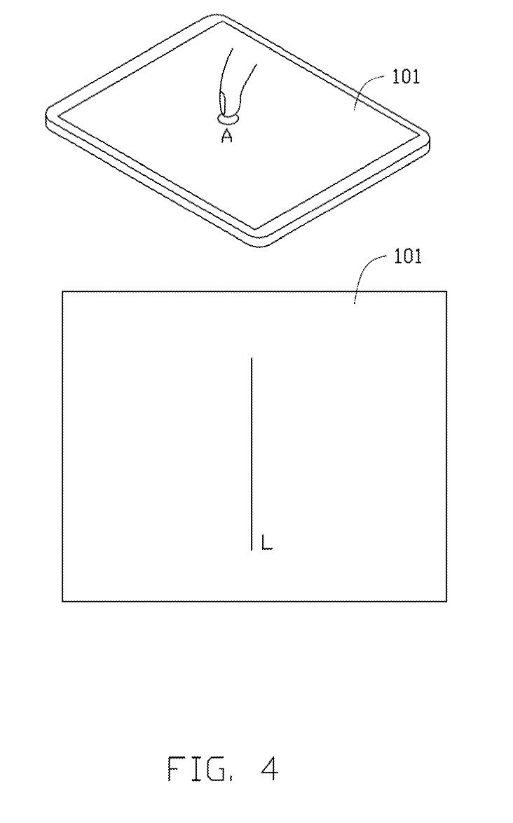

As illustrated in FIG. 4, when the touch input is applied at a single point A on the display screen 101, the image created by the processing unit 200 can be a straight line L extending from the point A. In at least one embodiment, a length of the line L can be adjusted according to the length of time of the touch input applied continuously at the point A.

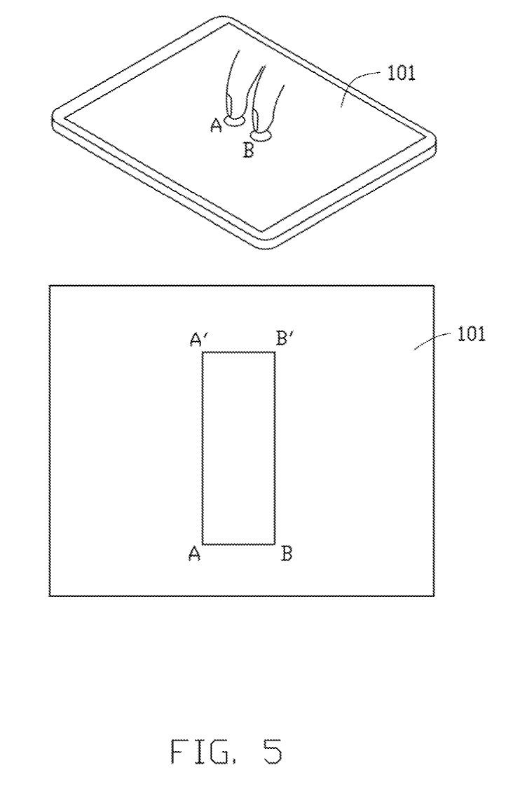

As illustrated in FIG. 5, when the touch input is applied at two points A, B, on the display screen 101, the image created by the processing unit 200 can be a quadrilateral plane extending from the points A, B to corresponding points A′, B′. In at least one embodiment, a length of the quadrilateral plane can be adjusted according to the length of time of the touch input applied continuously at the points A, B.

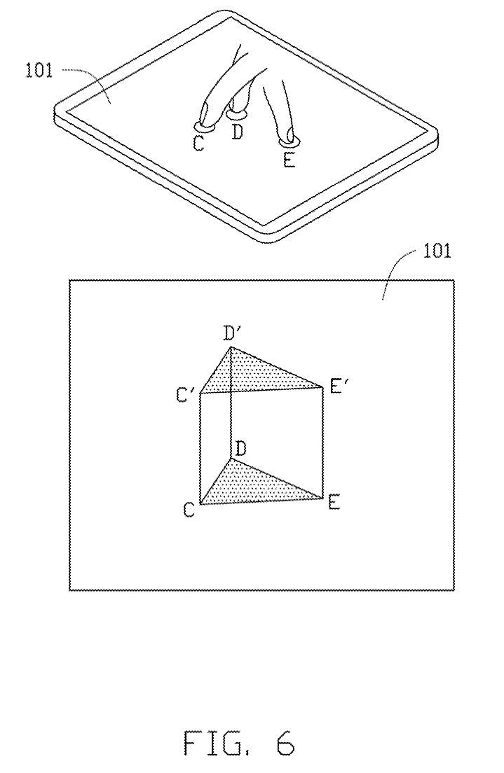

As illustrated in FIG. 6, when the touch input is applied at three points C, D, E, simultaneously on the display screen 101, the image created by the processing unit 200 can be a regular triangular prism extending from the points C, D, E to corresponding points C′, D′, E′. In at least one embodiment, a length of the regular triangular prism can be adjusted according to the length of time of the touch input applied continuously at the points C, D, E.

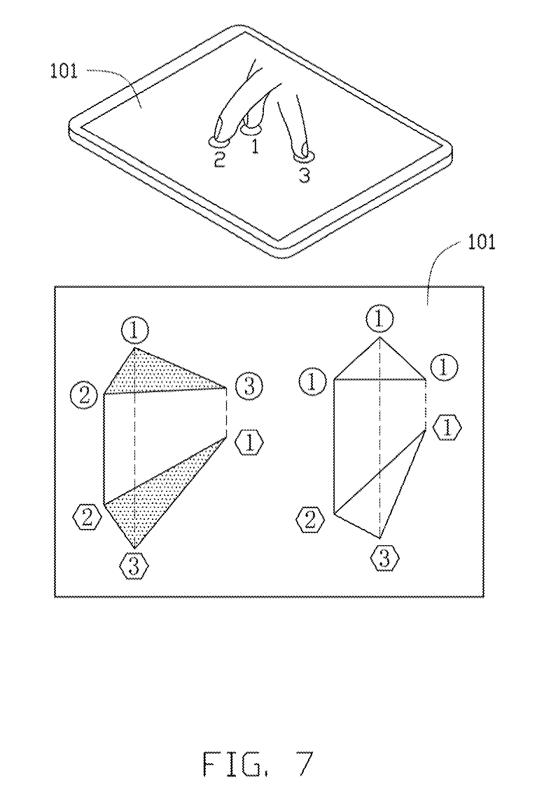

As illustrated in FIG. 7, when the touch input is applied at three points on the display screen 101, the image created by the processing unit 200 can be an irregular triangular prism. For example, when the touch input is applied at the three points at different times and released at different times, the processing unit 200 can extend the sides of the irregular triangular prism according to the length of time of the touch input being applied continuously at each of the corresponding points. In FIG. 7, the number 1 represents the point of the display screen 101 where the touch input was applied or released at an earliest time, 3 represents the point of the display screen 101 where the touch input was applied or released at a latest time, and 2 represents the point of the display screen 101 where the touch input was applied or released at a time between the earliest time and the latest time. In at least one embodiment, a length of the irregular triangular prism can be adjusted according to the length of time of the touch input applied continuously at the three points on the display screen 101.

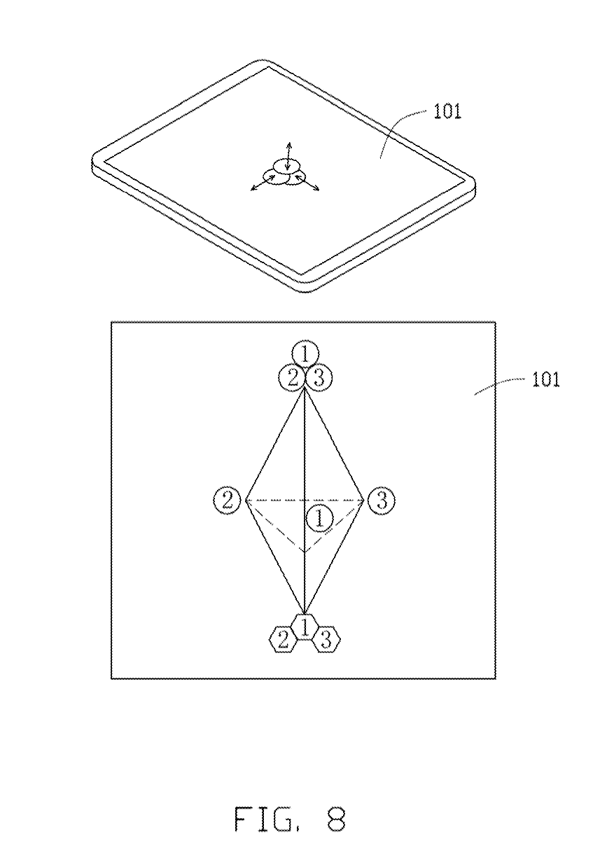

As illustrated in FIG. 8, when the touch input is applied at a single point of the display screen 101 and then expanded into three points, the image created by the processing unit 200 can be a triangular pyramid. When the touch input is applied at a single point of the display screen 101 and then expanded into three points and then contracted back to the single point, the image created by the processing unit 200 can be a double triangular pyramid joint at a shared triangular side. In at least one embodiment, a length of the triangular pyramid can be adjusted according to the length of time of the touch input applied continuously on the display screen 101.

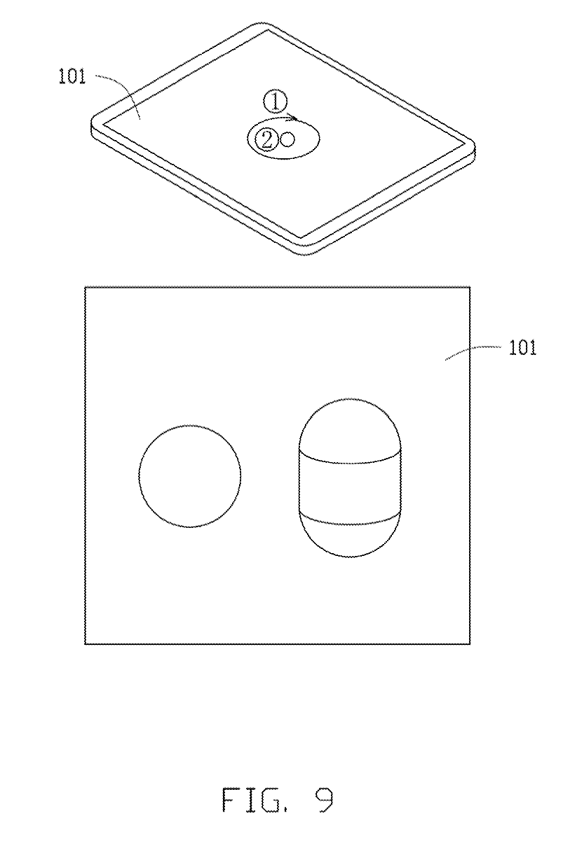

As illustrated in FIG. 9, when the touch input is first applied on the display screen 101 in a circular motion and then applied in a center of the circular motion, the image created by the processing unit 200 can be a sphere. When the touch input maintains contact with the display screen 101 in the center of the circular motion, a round-ended column can be created. In at least one embodiment, a length of the round-ended column can be adjusted according to the length of time of the touch input applied in the center of the circular motion on the display screen 101.

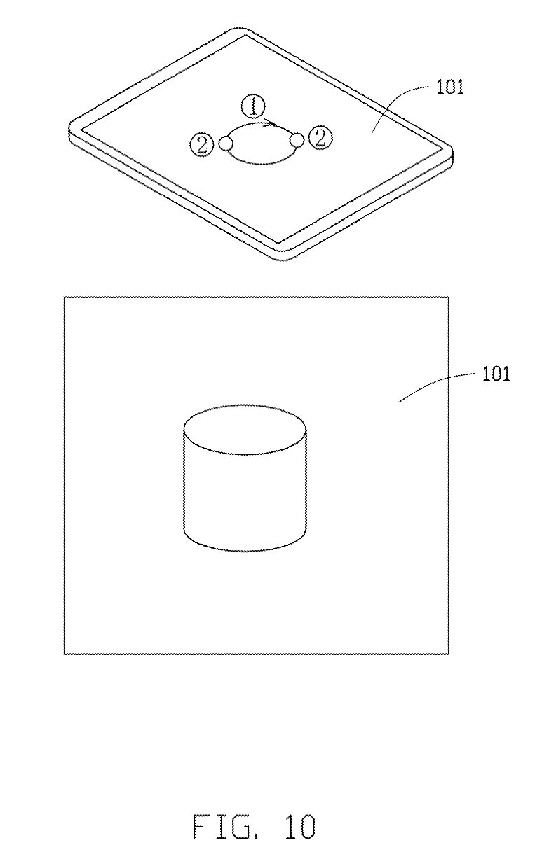

As illustrated in FIG. 10, when the touch input is first applied on the display screen 101 in a circular motion and then applied at opposite sides of the circular motion, the image created by the processing unit 200 can be a cylinder. In at least one embodiment, a length of the cylinder can be adjusted according to the length of time of the touch input applied continuously at the opposite sides of the circular motion on the display screen 101.

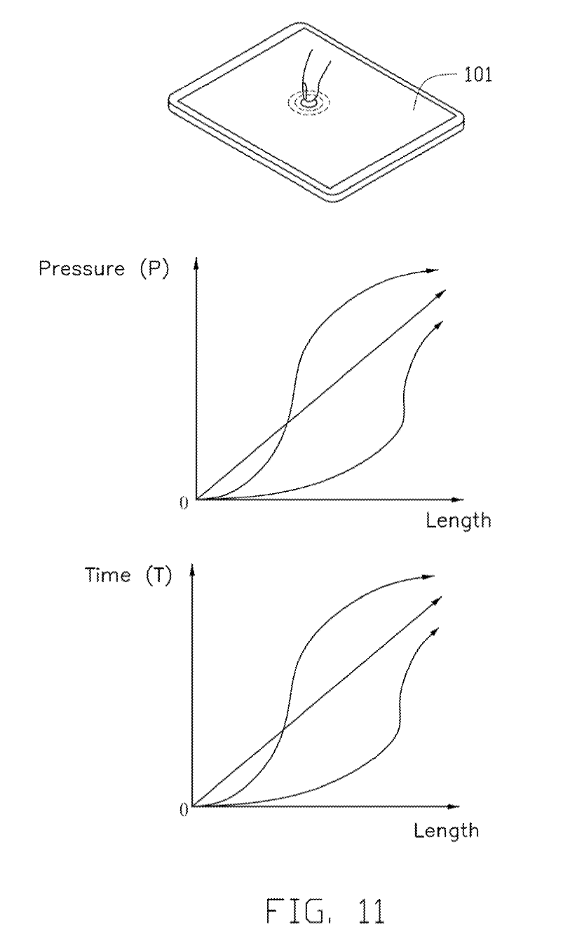

As illustrated in FIG. 11, in another embodiment, the length of the image can be adjusted according to pressure. Whether the image is extended according to the length of time of the touch input or according to pressure, the image can be extended linearly or non-linearly according to a predetermined extending algorithm.

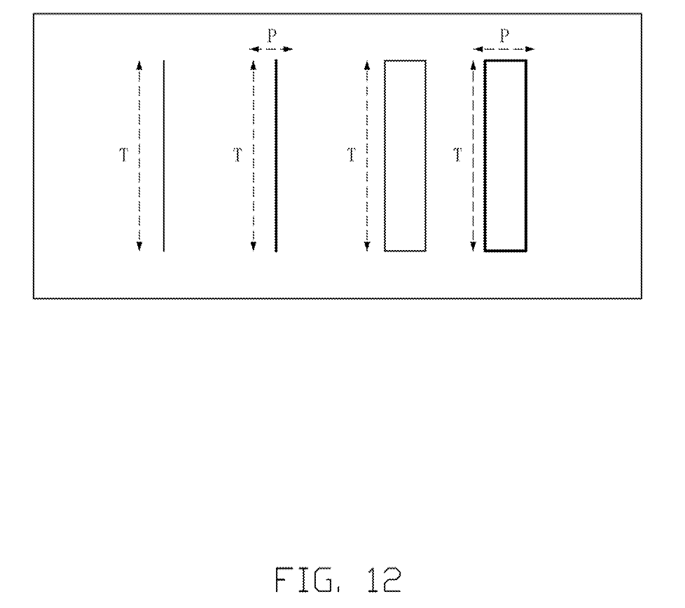

As illustrated in FIG. 12, in at least one embodiment, the length of the image can be adjusted according to the length of time (T) while a line thickness of the image can be adjusted according to the pressure (P). After the image has been created, a second touch input can be applied on the image and a color of the image can be adjusted according to a length of time of the second touch input applied continuously on the image. The color and a shade of the color can be adjusted by the pressure of the second touch input. A relationship between the color and shade of the color and the pressure can be saved in the storage unit 206.

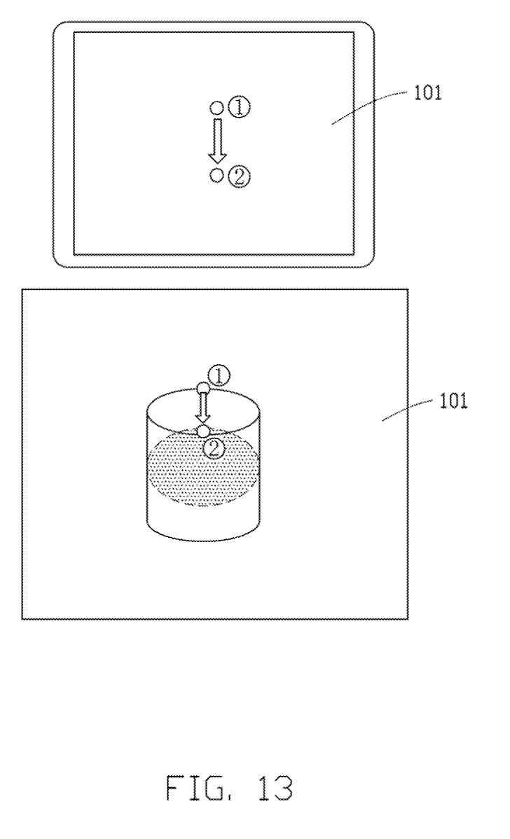

As illustrated in FIG. 13, in at least one embodiment, the second touch input can be applied on any point 1 of the display screen 101 after the image has been created. The second touch input can be moved along the display screen 101 to a point 2, and the processing unit 200 can rotate the image in a direction corresponding to a direction of movement of the second touch input. In another embodiment, the processing unit 200 can move the image in a direction corresponding to the direction of movement of the second touch input.

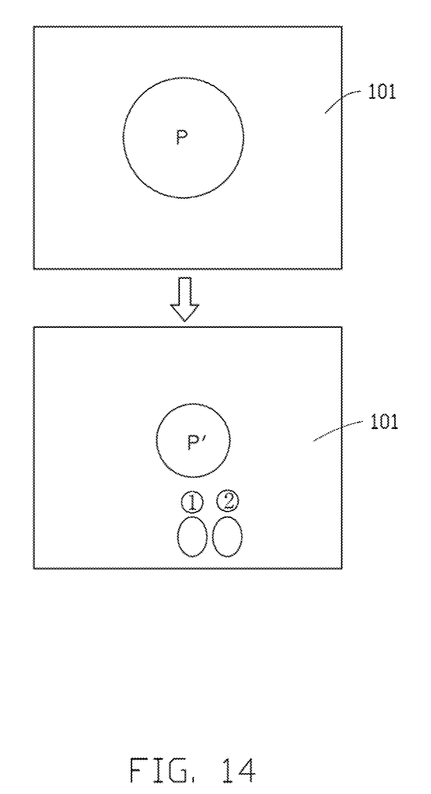

As illustrated in FIG. 14, after an image P has been created, the second touch input can be applied at two points 1 and 2 on the display screen 101 and contracted together to scale down a size of the image to create a smaller image P′.

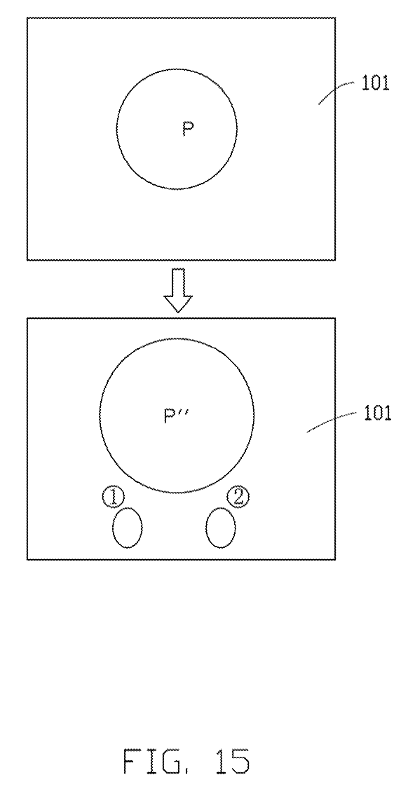

As illustrated in FIG. 15, after the image P has been created, the second touch input can be applied at two points 1 and 2 on the display screen 101 and expanded to scale up a size of the image to create a bigger image P″.

In at least one embodiment, after the image has been created, the length of the image can be reduced by applying the second touch input on the display screen 101 in a circular motion in a clockwise direction. The length of the image can be increased by applying the second touch input on the display screen 101 in a circular motion in a counterclockwise direction. A speed and a number of times of applying the second touch input in the circular motion can determine a degree of adjusting the length of the image.

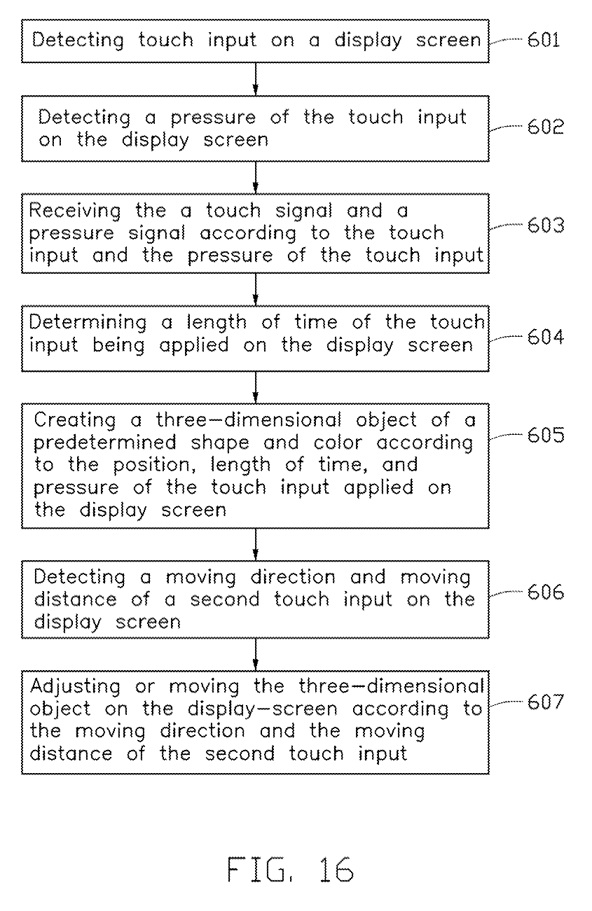

FIG. 16 illustrates a flowchart of an exemplary method for creating a three-dimensional image. The method is provided by way of example, as there are a variety of ways to carry out the method. The method described below can be carried out using the configurations illustrated in FIGS. 1-15, for example, and various elements of these figures are referenced in explaining the example method. Each block shown in FIG. 16 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 601.

At block 601, a touch sensor of the electronic device can detect touch input on a display screen thereof. The touch input can be applied at a single point on the display screen or at a plurality of points.

At block 602, a pressure sensor of the electronic device can detect a pressure of the touch input on the display screen.

At block 603, a processing unit of the electronic device can receive a touch signal and a pressure signal from the touch sensor and the pressure sensor, respectively.

At block 604, the processing unit can determine a length of time of the touch input being applied on the touch-sensitive display.

At block 605, the processing unit can create a three-dimensional object of a predetermined shape and color according to the position, length of time, and pressure of the touch input applied on the touch-sensitive display. In at least one embodiment, a shape of the object created is determined according to the number of points on the display screen where the touch input was applied. In at least one embodiment, the length of time that the touch input was applied on the display screen can determine a length of the object, and a pressure of the touch input applied on the display screen can determine a color of the object.

At block 606, the processing unit can detect a moving direction and moving distance of a second touch input being moved along the display screen.

At block 607, the processor can adjust or move the three-dimensional object on the display-screen according to the moving direction and the moving distance of the second touch input. In at least one embodiment, the moving direction and the moving distance of the second touch input can correspond to a size of the object being scaled up or scaled down. In another embodiment, the second touch input can correspond to rotating the object along the moving direction.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An electronic device for creating a three-dimensional image, the electronic device comprising:
a display unit comprising:
a display screen; and
a touch sensor electrically coupled to the display screen and configured to generate a touch signal in response to a touch input applied on the display screen; and
a processing unit configured to:
receive the touch signal and determine a position of the touch input applied on the display screen;
determine a length of time of the touch input being applied continuously on the display screen; and
create an image on the display screen according to the position and length of time the touch input was applied on the display screen.

2. The electronic device as in claim 1, wherein:
the processing unit is configured to detect a moving direction and a moving distance of the touch input on the display screen;
the processing unit receives a moving direction signal and a moving distance signal from the touch sensor according to the moving direction and the moving distance of the touch input; and
the processing unit adjusts the image according to the moving direction signal and the moving distance signal.

3. The electronic device as in claim 2, wherein:
the display unit comprises a pressure sensor configured to detect a pressure of the touch input on the display screen;
the pressure sensor transmits a corresponding pressure signal to the processing unit; and
the processing unit adjusts a line thickness of the image according to the pressure signal.

4. The electronic device as in claim 3, wherein the processing unit comprises a storage unit configured to store a table of a plurality of colors corresponding to different values of pressure and length of time of the touch input; and
the processing unit adjusts the color of the image according to the pressure or the length of time of the touch input.

5. A method for creating a three-dimensional image, the method comprising:
receiving a touch signal from a touch sensor of touch input applied on a display screen and determining a position of the touch input on the display screen according to the touch signal;
determining a length of time of the touch input being applied continuously on the display screen; and
creating an image on the display screen according to the position and the length of time the touch input was applied on the display screen.

6. The method as in claim 5 comprising:
receiving a moving direction signal and a moving distance signal from the touch sensor according to a moving direction and a moving distance of the touch input on the display screen; and
adjusting the image according to the moving direction signal and the moving distance signal.

7. The method as in claim 5 comprising:
receiving a pressure signal from a pressure sensor according to a pressure of the touch input on the display screen; and
adjusting a line thickness of the image according to the pressure signal.

8. The method as in claim 7 comprising:
obtaining a corresponding color according to the pressure signal from a table stored in the electronic device; and
adjusting a color of the image according to the pressure signal.

9. The method as in claim 5 comprising:
rotating the image, after the image has been created, according to a second touch input applied on any portion of the display screen and being moved along the corresponding direction along the display screen; and
moving the image, after the image has been created, according to the second touch input applied on any portion of the display screen and being moved along the corresponding direction along the display screen.

10. The method as in claim 5 comprising:
adjusting a size of the image, after the image has been created, according to a contraction or an expansion of a second touch input applied on the display screen.
